(19) United States
(12) Patent Application Publication
(10) Pub. No.: US 2021/0374878 A1
(43) Pub. Date: Dec. 2, 2021

(54) SYSTEMS AND METHODS FOR VIEWING, RATING, AND RANKING CONTENT

(71) Applicant: Alexander Wayner, Brooklyn, NY (US)

(72) Inventor: Alexander Wayner, Brooklyn, NY (US)

(21) Appl. No.: 17/323,168

(22) Filed: May 18, 2021

Related U.S. Application Data
(60) Provisional application No. 63/033,797, filed on Jun. 2, 2020.

(51) Int. Cl. G06Q 50/00; G06Q 30/02

(52) U.S. Cl. CPC G06Q 50/01; G06Q 30/0201

(57) ABSTRACT

A system for ranking creative content online is provided that includes at least once computing device communicatively coupled to a plurality of other devices over a computer network. The at least one computing device is configured at least to: cause a first interface screen to be displayed on at least one of the plurality of the other computing devices, the first interface screen including therein at least one form element for a content creator to upload media content to the at least one computing device; receive and mark the uploaded media content with an upload date and time; assign the media content received to one of a plurality of modes, comprising a recent mode, wherein the media content is assigned to the recent mode and continues to be associated with the recent mode for a first period of time that begins at the upload date and time; and cause a second interface screen to be displayed on the plurality of the other devices, the second interface screen including a plurality of selectable tabs each corresponding to the plurality of the modes, including a recent tab that when selected displays media content associated with the recent mode, the second interface screen comprising at least one selectable icon for users to assign a first rating to media content associated with the recent mode.

### BACKGROUND OF THE INVENTION

The present application relates to systems and methods for viewing, rating, and ranking creative content shared online, and more specifically, an online platform for sharing and viewing creative content where both content consumers and content creators can receive awards based on consumers' content preferences.

Many talented performers across different genres suffer from the inability to show their creative work to a large audience. For many years, most of them remain unrecognized and “lost in the jungle” of large-scale platforms for sharing content, such as YouTube or Facebook. Correspondingly, consumers may find it difficult to identify content from the enormous volume of content hosted on the platforms.

Most of the presently available rating systems on content viewing platforms are based on the principle of likes and dislikes. The number of likes and dislikes frequently depends on the number of viewers of that content. Content that achieves a large viewership for a given time is primarily due to two reasons: first, when the content creator is a high profile or famous person with a large number of followers, and second, when the content creator has significant funding to advertise his or her content. However, most young, talented individuals have neither of these options, therewith making it difficult for them to reach viewers and difficult, if not impossible, for viewers to become aware of relevant media from such individuals.

Currently, there is no online platform that addresses this problem, that is, for identifying content for viewers irrespective of the likes/dislikes. Accordingly, there is a need for a platform that identifies the most talented or popular performances among competing content creators, for example, based on viewers' choices, without the undesired influence from factors, such as creator's privilege or the unequal economic position of competitors, which distorts the desirability of media content online. Additionally, there is no online platform that provides content viewers the opportunity to both view content, and also to vote for the best content and receive rewards for making the correct or most popular choice.

Accordingly, there is a need for an online content sharing and viewing platform that is not so limited.

### SUMMARY OF INVENTION

In one aspect, a system for ranking creative content online is provided that includes at least once computing device communicatively coupled to a plurality of other devices over a computer network. The at least one computing device is configured at least to: cause a first interface screen to be displayed on at least one of the plurality of the other computing devices, the first interface screen including therein at least one form element for a content creator to upload media content to the at least one computing device; receive and mark the uploaded media content with an upload date and time; assign the media content received to one of a plurality of modes, comprising a recent mode, wherein the media content is assigned to the recent mode and continues to be associated with the recent mode for a first period of time that begins at the upload date and time; and cause a second interface screen to be displayed on the plurality of the other devices, the second interface screen including a plurality of selectable tabs each corresponding to the plurality of the modes, including a recent tab that when selected displays media content associated with the recent mode, the second interface screen comprising at least one selectable icon for users to assign a first rating to media content associated with the recent mode.

In one embodiment, the first period of time is a set amount of time for all media content.

In one embodiment, the second interface screen comprising at least one other selectable icon for users to assign a second rating to media content associated with the recent mode, the first and second ratings representing different media characteristics.

In one embodiment, the at least once computing device further configured to assign the media content received to a second of a plurality of modes, comprising a battle mode, wherein the media content is assigned to the battle mode at a next available calendar day after a completion of the first time period and continues to be associated with the battle mode for a second period of time.

In one embodiment, the at least once computing device further configured to assign the media content received to a third of a plurality of modes, comprising a trend mode, wherein the media content is assigned to the trend mode after a completion of the second time period and continues to be associated with the battle mode for a third period of time.

In one embodiment, the second interface screen includes a battle tab that when selected displays media content associated with the battle mode, the second interface screen comprising at least one selectable icon for users to assign a third rating to media content associated with the battle mode.

In one embodiment, the third rating comprises a currency and wherein the at least one icon comprises a plurality of coins at different denominations, and wherein the at least one computing device tabulates a total of the currency earned at a completion of the third period of time.

In one embodiment, the at least one computing device periodically credits system users with points for use in each of the ratings.

In one embodiment, the second interface screen includes a trend tab that when selected displays media content associated with the trend mode, the second interface screen comprising at least one selectable icon for users to assign a fourth rating to media content associated with the trend mode.

In one embodiment, the fourth rating comprises likes and wherein the at least one icon comprises a like icon and a dislike icon, and wherein the at least one computing device tabulates net likes at a completion of the third period of time.

In one embodiment, the at least one computing device removes media content from the trend mode when net likes fall below a threshold.

In one embodiment, the media content can only be assigned to one of the plurality of modes, and wherein the at least one computing device transfers the media content between modes automatically upon completion of the respective period of times.

In one embodiment, the second interface screen comprising at least one other selectable icon for users to assign a second rating to media content associated with the recent mode, and wherein the at least one computing device tabulates the first and second ratings at the complete of the first period, and assigns media content having a highest of the first and second ratings to the battle mode.

In one embodiment, in the battle mode, media content having the highest first rating is paired against media content having the highest second rating.

In one embodiment, the at least one selectable icon allows users to assign a limited amount of currency to media content associated with the battle mode.

In one embodiment, the at least one computing device identifies at least one battle mode winner for each of a plurality of categories of media content.

In one embodiment, the at least one computing device awards points to users rating winning media content.

In one embodiment, the at least one computing device tabulates normalized ratings and identifies at least one battle mode winner based on normalized totals.

Other embodiments will be appreciated by those skilled in the art and the inventions disclosed herein are therefore not limited thereto.

### BRIEF DESCRIPTION OF THE FIGURES

FIG. 1 shows a system diagram for viewing, rating, and ranking creative content shared online according to an embodiment of the present invention.

FIGS. 2-4 shows an interface of a computing device showing the Recent Section which represents recently uploaded videos and user control functions according to an embodiment of the present invention.

FIG. 5 shows an interface of a computing device showing a Battle Section which represents a competition between users regarding a recently uploaded video according to an embodiment of the present invention.

FIG. 6 shows an interface of a computing device showing a Trends Section which represents trending videos according to an embodiment of the present invention.

FIGS. 7-13 show charts illustrating the functionality of the system according to one or more embodiments of the present invention.

FIG. 14 illustrates a process for viewing, rating, and ranking creative content shared online according to an embodiment of the present invention.

FIG. 15 shows an interface of a computing device showing a screen for users to filter uploaded videos according to an embodiment of the present invention.

FIG. 16 shows an interface of a computing device showing a user accounting for users to view and use account balances, convert points from and to virtual currency, send points and/or virtual currency to other users, purchase items from, e.g., a gift shop, and withdraw money from the account according to an embodiment of the present invention.

FIG. 17 shows an interface of a computing device showing a user transfer points and/or virtual currency to over users according to an embodiment of the present invention.

FIG. 18 shows an interface of a computing device showing a leader board according to an embodiment of the present invention.

FIG. 19 shows an interface of a computing device showing a high-level navigation menu according to an embodiment of the present invention.

FIG. 20 shows an interface of a computing device showing results of a debate poll according to an embodiment of the present invention.

FIG. 21 shows an interface of a computing device showing a screen with buttons for users to vote on a poll according to an embodiment of the present invention.

FIG. 22 shows an interface of a computing device showing a video history screen that provides the user's video history and points accounting according to an embodiment of the present invention.

### DETAILED DESCRIPTION OF THE INVENTION

The present application generally provides methods and systems for viewing, rating, and ranking creative content shared by content creators online, and more specifically, an online platform for content creators to share creative content and for consumers to be better able to identify relevant content, and for both content consumers and content creators to receive awards based on viewers' content preferences. The system guarantees each content creator the equal opportunity to be viewed by a large audience of viewers and receive ratings on content based on consumers' reactions without the distortion to ratings caused by undesired influence of factors, such as the creator's privilege or unequal economics. The system will be discussed herein by way of example with respect to certain types of multimedia content, such as photos, video, clips, etc. It is understood, however, that the system is equally applicable to other forms of consumable media, including text/books, audio, music, etc., and the invention(s) disclosed herein are therefore not limited to the exemplary embodiments discussed herein.

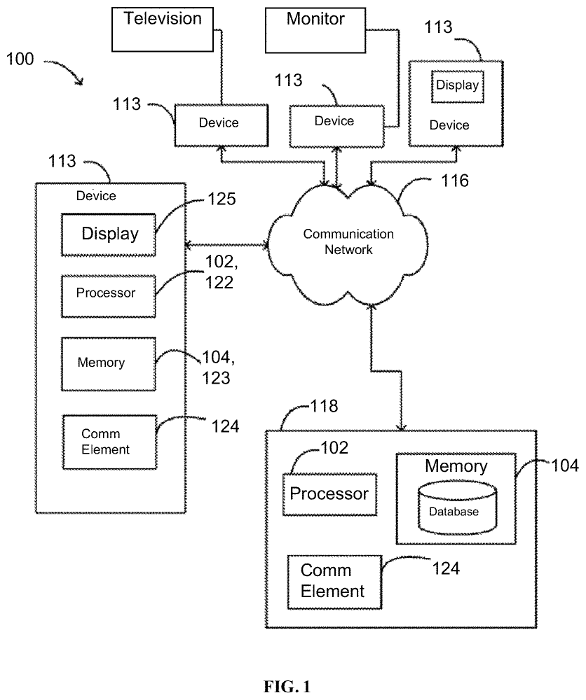

Referring to FIG. 1, a system 100 according to at least one embodiment of the systems disclosed herein includes at least one computing device, such as a remote computer 118, e.g., a server computer, a client device 113, or a combination thereof. The computing device generally includes at least one processor 102, and a memory 104, such as ROM, RAM, FLASH, etc., or any tangible computer readable medium 106, such as a hard drive, a flash drive, an optical or magnetic disk, etc. The memory 104 or other tangible computer readable medium 106 preferably includes software stored thereon that when executed performs one or more steps of the methods disclosed herein, including communicating data back and forth between devices, displaying interface screens, etc. The computing device may also be associated with or have access to one or more databases for retrieving and storing the various types of data discussed herein.

In one embodiment, the system 100 includes a plurality of computing devices, such as a remote computer 118 coupled to at least one client or other device 113 over a communication network 116, which are generally configured or otherwise capable of transmitting and/or receiving communications to and/or from each other. The term remote in this context merely means that the remote computer 118 and the client device 113 are separate from each other. Thus, the devices may be remote even if the devices are located within the same room. As such, the client device 113 is preferably configured or otherwise capable of transmitting and/or receiving communications to and/or from the remote computer 118. This may be accomplished with a communication element 124, such as a modem, an Ethernet interface, a transmitter/receiver, etc., that enables communication with a similarly equipped remote computer 118, wirelessly, wired, or a combination thereof. It is understood that the relative functionality described herein may be provided by the remote computer 118, by the client device 113, or both, and is thus not limited to any one implementation discussed herein.

The system may include several server computers 118 coupled over the network 116, each providing its relative functionality. For example, a first server(s) may provide functionality for uploading and storing creator content, and for consumer viewing of such creator content, etc., whereas a second sever(s) may provide functionality enabling consumers to rate creator content and maintaining a ranking of such content made available via the first server(s), and providing awards to consumers/viewers and creators as discussed herein. Moreover, the first and second server(s) may be operated by different entities.

The client devices 113 may include, without limitation, a mobile phone or tablet, personal computer, as well as any special or general purpose client device, such as a cable TV box, a web TV box, etc. As such, the client device 113 preferably includes a processor 122, a memory 123, a display 125, such as a CRT or an LCD monitor or screen, for displaying the media content provided by the system 100, and at least one input device, such as a mouse, a touch-sensitive pad, a pointer, a stylus, a trackball, a button, e.g., alphanumeric, a scroll wheel, a touch-sensitive monitor or screen, etc., or a combination thereof, for users to enter commands and/or information relevant to the system's services. With the general-purpose type client devices 113, such as the PC or mobile device, users may access the services provided by the system 100, e.g., the remote computer 118, with a browser or any other generic application, or with special purpose software/applications designed specifically for accessing and providing the services disclosed herein. For example, the functionality discussed herein may be provided by an application that includes software or instructions for execution and display on a computing device, that, when executed, performs one or more steps of the methods disclosed herein, including displaying interface screens and enabling consumer interaction therewith as also discussed herein. The application may be configured to run on several operating systems, such as iOS, Android, and any other mobile operating system or PC operating system.

It is understood that the present processes may be implemented to enable consumers and/or the provider to view, rate, and rank creative content in all types of electronic information distribution networks, including websites, streaming services, or any service that allows users to share and/or view creative content.

In one embodiment, the system provides for users, which may be either content consumers/viewers, content creators, or both, one or more interface screens that allow users to interact with the system. A content creator interaction may include enabling the user upload creative content, such as video clips, to the server(s). Creative content may include, but is not limited to photo, video, audio, textual material, etc. A content viewer may view and interact with creative content uploaded to the server, as discussed herein. A content viewer that has registered with the system (e.g., by creating an account using an email address or social media account) may be provided with additional privileges and options to interact with the system than a viewer that has not registered.

In one embodiment, creative content is assigned a subject category and may further be assigned a sub-category. In this regard, the system 100 may maintain one or more databases that associate creative content with at least one of a subject category and a sub-category. In one embodiment, the category and sub-category are assigned by the content creator but may be assigned by anyone or by the system itself.

The system 100 may cause an interface to be displayed at a computing device associated with the content creator containing a list of categories for the content creator to select and therewith associate with the creator content. Creator content categories may include, but are not limited to 6 major categories like Dance & Music, LOL (for comedy), Vibes (for teens), Speak Out (open talk), News & Views (events), Other. Each creator content category may include a plurality of selectable sub-categories. The system 100 may cause an interface to be displayed at a computing device associated with the content creator containing selectable sub-categories of each of the subcategories. The sub-categories for the creator content category of Music, for example, may include, but are not limited to, pop, rock, rap, hip hop, jazz, classical, retro, and other. It is understood that other interface schemes may be used to associate content with categories, including form elements, such as text boxes, drop down menus, etc., each enabling the user to select a category and/or subcategory for the creator content.

In one embodiment, the system 100 provides for at least three modes or sections in which content consumers/viewers may view and interact with content uploaded by a content creator. The three modes may include Recent, Battle, and Trends modes. A viewer may enable the option of selecting the desired viewing mode, for example, from a high-level drop-down menu or tabs.

In one embodiment, users may interact with and further rate creator content by awarding Stars, Hearts, Coins (Gold, Silver, Bronze), Likes & Dislikes to the content, as described herein. In one embodiment, every user that registers with the system receives a daily credit of, for example, 25 stars, 25 hearts and 30 coins (e.g., 10 Gold coins, 10 Silver coins and 10 Bronze coins), which the user may award to content as described herein. A user may purchase additional stars, hearts and coins in the system. A user may also rate creator content by giving likes or dislikes. Likes and dislikes are free of charge, and a user is not limited by the number of likes and dislikes that may be awarded to content. In one embodiment, users may rate creative content by assigning it a single like or a dislike. In this regard, the system 100 maintains one or more databases that associate and tracks Stars, Hearts, Coins, Likes and Dislikes with content, and one or more databases that associate and track Stars, Hearts, Coins, purchased and/or assigned to the given content.

In one embodiment, the Recent mode may filter and show videos or other media content based on recency of their upload by content creators. For example, when a content creator uploads video content to the server, it may be initially displayed in the Recent mode section of the application for a certain time period indicative of recency, such as 24 hours, a full calendar day, etc. When a consuming user first launches the software application on a device associated therewith, the system will preferably start the application in the Recent mode section by default.

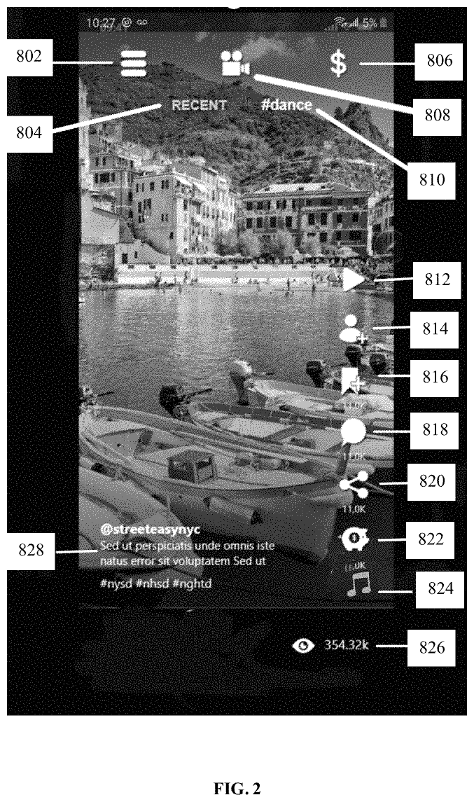

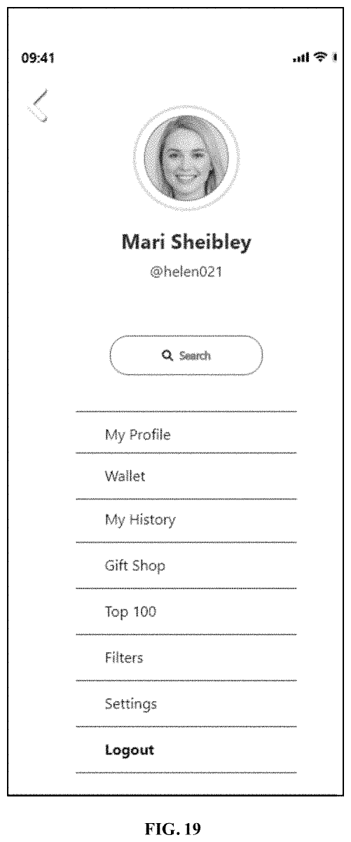

Referring to FIG. 2, an interface screen displayed on a computing device associated with a consuming user is shown, which displays a recently uploaded video. As can be seen, the Recent mode is enabled (confirmed by highlighting the “recent” tab 804 from the plurality of other available mode selection tabs) indicating that the user is being provided a recent video for viewing, rating, etc. A settings button in the shape of a person icon 802 may be provided for access to a user's profile information/settings, including a photo of the user, date of birth, user name and password, email address, phone number, and/or an option to delete account. An exemplary interface screen with navigation menu for, inter alia, entering the setting is shown in FIG. 19.

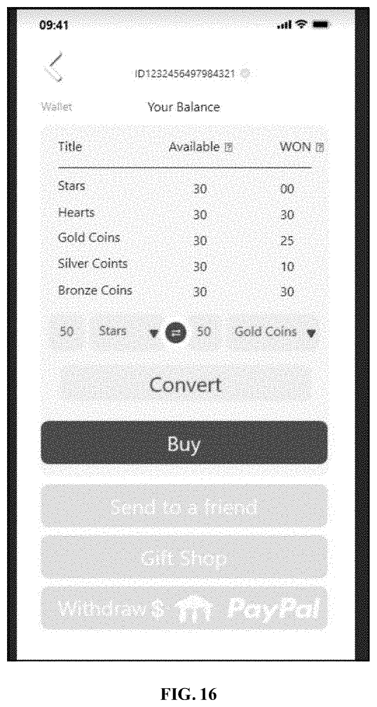

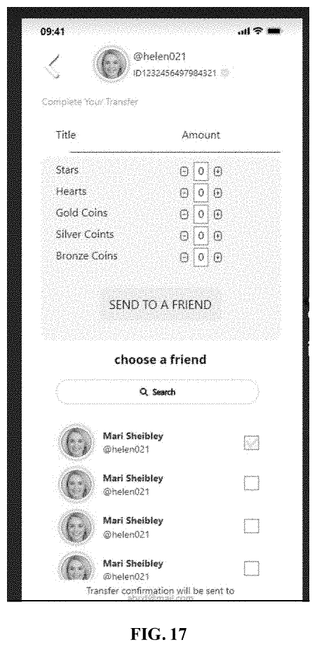

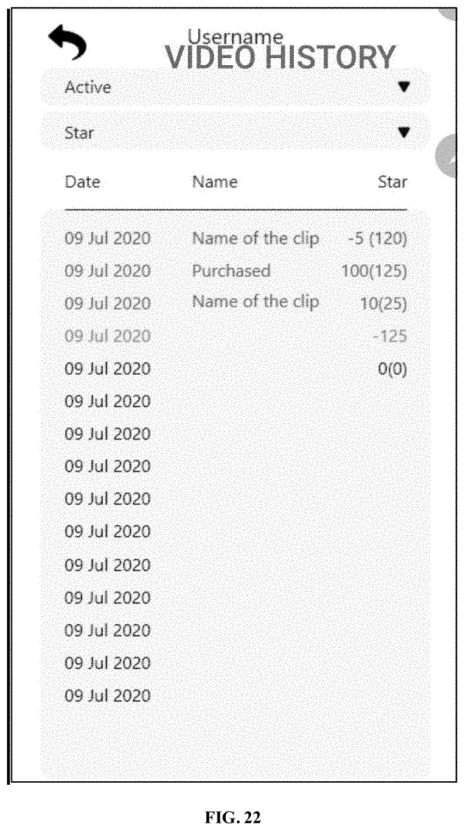

This interface screen may also include selectable sections, such a My Videos section, containing a photo of the user; user name; manage video, edit, delete options; number of stars and likes available; list of followers; comments; and shares. This interface screen may also contain a Favorites section, containing a list of other users a user follows. This interface screen may also contain a Payment section, with credit card information, for example, for the user to pay for purchases of Stars, Hearts, Coins, etc. The interface screen may contain a My Wallet section, containing stars, hearts/coins on/off, stars, hearts/coins balance, buy stars, hearts/coins (online store), and stars, hearts/coins transaction history, with history of date, name of video, and amount of stars, hearts/coins spent. An exemplary interface screen in this regard is shown in FIG. 22. This interface screen may also contain a Gift selection with history of date, name of video, and amount of stars, hearts/coins spent. This interface screen may also contain a Gift Shop selection, containing products, option to use gift cards, and option to send cash by Paypal® or to the consumer's bank account. This interface screen may also contain Video Filter Settings selection, including notification settings and recording settings. Exemplary interface screens in this regard are shown in FIGS. 16-17.

A camera button 808 may be provided, which a user may select to record video that is to be uploaded to the system or to upload previously recorded video or other content. A search bar located inside in the Menu 802 may be provided to enable users to search for video or other media content using, for example, keywords. A set of mode selection tabs 804 may be provided to enable users to navigate between modes, such as Recent, Battle, Trends.

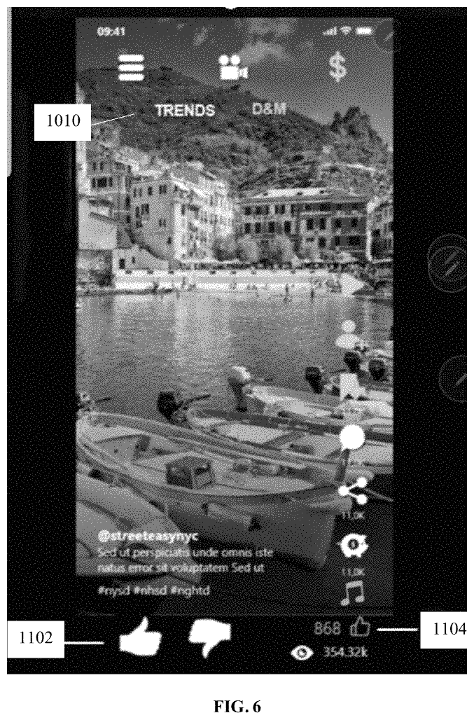

Preferably, the interface screen, for example, for the Trends mode, displays a row of selectable icons (as shown in FIG. 6 (1102)) for assigning likes and dislikes, and for submitting the same to the system. An icon tracking the number representing the balance between likes and dislikes that have been given to a given video 1104 may also be provided. If the balance of likes and dislikes reaches −50 or other threshold, the video may be relocated from the Trends mode to the user's profile page. At the bottom of the Recent mode interface screen, the name of the video 828 and the total number of views 826 may be provided. Selectable icons may be provided for the consumer to, for example, autoplay 812, to follow the content creator user 814, add video to favorites 816, comment 818, share 820, gratuity 822, etc.

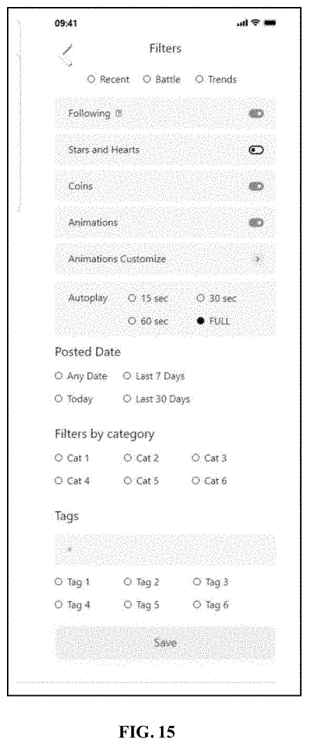

In one embodiment, the All mode may show all videos that have been uploaded by all content creators. In this mode, a listing of all videos that have been uploaded may be provided. Videos may be sorted/filtered by category, subcategory, hashtag, upload date, and more, for example, using the interface screen shown in FIG. 15.

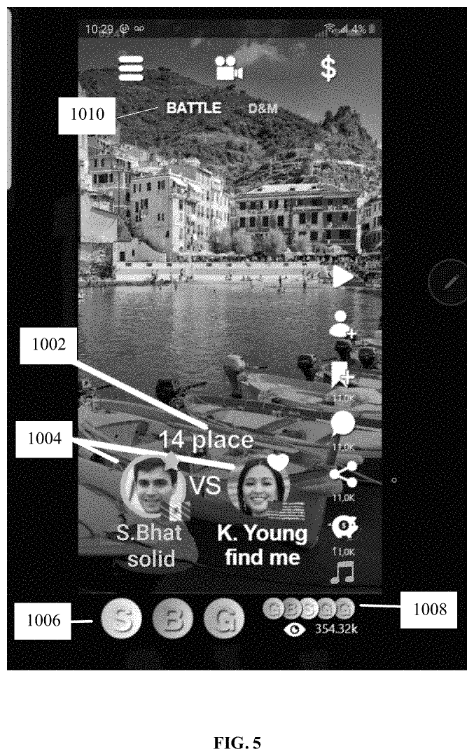

In one embodiment, the Battle mode may show icons of the video with the highest star and heart, as shown in FIG. 5.

An interface of a computing device showing sort options for creator content may be provided according to an embodiment, which allows a user to sort and/or filter creator content, select modes, to disable stars, hearts and coins, to turn off or customize animations, to choose autoplay timing, and select category, sub-category, upload date, etc., for example. A user may sort and/or filter creator content according to viewing mode: Recent, Battle, Trends. The Recent section will preferably contain fresh videos which were uploaded for the past 24 hours, for example, sorted by recency (newest first). All new releases/uploads will preferably go to this section.

The Battle section may contain videos, which were uploaded and outside of the recency period, i.e., the Battle time period, e.g., for the past with the greatest star and hearts ratings (to determine gold, silver, and bronze winners in each subcategory). The Trends section will preferably contain all the rest of the videos which were uploaded to the system beyond the recency period and preferably beyond the Battle period, e.g., greater than 72 hours ago.

A user may sort creator content according to upload date to show content uploaded today, this week, this month, or any date. A user may also set the play mode to auto play, wherein the next video automatically plays after a selected video.

In one embodiment, rules and privileges for content creators and content viewers are provided. A content creator may upload a video to the system or create a video using the record feature in the system software, as discussed above, but the system may impose a video length limit depending on category, e.g., one minute or less for Lol, Vibes, Speak Out, News & Views, and Other, but up to six minutes, for Music/Dance. After a content creator submits a video to the system, it will be displayed in the Recent section for the recency time period, e.g., 24 hours. A timer will preferably count down from 24 hours for the video in the Recent section. During this time, the video may accumulate stars and hearts awarded by users. Stars are earned for the performance, whereas hearts for the appearance.

The timer may be configured to ensure that each content creator's video has an equal opportunity to be viewed by a large audience for a given recency period that begins on any particular date. For example, say video clip A was uploaded at 1:20 am on Feb. 2, 2020. The system will allow clip A to be viewed in the Recent section and be eligible to receive stars from viewers until 1:20 am on Feb. 3, 2020. If video clip B was uploaded at 11:59 pm on Feb. 2, 2020, the same day as video A, then the system will allow clip B to be viewed in the Recent section and be eligible to receive stars from viewers until 11:59 pm on Feb. 3, 2020. The system will determine the winner of the day—in this example, Feb. 2, 2020—at 12:00 am on Feb. 4, 2020, from all videos uploaded on that date. Accordingly, every video uploaded on a certain calendar day will receive the exact amount of time to be viewed in the Recent section and be eligible to receive stars and hearts from viewers before being ranked against other videos uploaded on that day.

The three videos with the greatest stars and hearts rating (i.e., total number of stars or hearts) in a given category will preferably be identified by the system as the star and heart winners of the day. The top three videos with the highest number of stars or hearts (in each subcategory) for the period of seven days and a month's time may be designated winners of the week and month, respectively. The video of each month will preferably participate in an annual competition at the end of the year for the title of the best video of the year. While a video is in the Recent section, a user may award stars or hearts to the video during the 24-hour recency period. After 24 hours, a video in the Recent mode may be transferred to the Battle section. After 24 hours in the Battle section a video gets transferred to the Trends Section and will only be viewable in those sections. In one embodiment, a user may rate a video he or she likes in Recent by awarding it a number of stars or hearts, up to a maximum of 5 stars or 5 hearts. In the Battle section, user may also award coins gold, silver and bronze. In the Trends section user may give likes or dislikes to a video. A registered user of the system may have awarding privileges that an unregistered user does not have, e.g., an unregistered user may only be able to award likes and dislikes, but not stars, hearts or coins. In one embodiment, likes and dislikes may be awarded to a video at any time, i.e., it is not limited to the first 24 hours after a video is uploaded. In contrast to the stars, hearts or coins rating, which is calculated after the close of a 24-hour period, likes and dislikes may not be calculated subject to any time limit. If a user awards stars, hearts to a video that subsequently has the highest star or heart rating, the user may win star or heart awards, as described herein.

Likes and dislikes may be awarded at any time while a video is in the Trends section. The net total of likes and dislikes is determined by subtracting the number of dislikes from the number of likes. If the number of dislikes exceeds the number of likes, a negative balance is created. In one embodiment, if a video receives a negative balance of 50 dislikes, it will automatically be removed from Trends Section and will be available for views only at the creator's profile page. If such video subsequently accumulates a positive balance of likes, it will be restored to the Trends section. Each like or dislike may have a feature that appears on the screen as a gif representing positive or negative user's reaction to a video. The feature may be turned on or off if desired.

In a one embodiment, a Battle mode section for viewing creator content is provided. The Battle mode shows the video with the highest star and the video the highest heart ratings within each category and sub-category.

Referring to FIG. 5, an interface of a computing device showing competitions between two content creators (1004) for each category (1010) of creator content according to an embodiment of the present invention is provided. These videos represent the video with the highest star rating and the video with the highest heart rating for that calendar day. Such videos may participate in a Battle competition for viewers to judge.

Each day, the video with the highest star rating in each category or sub-category for that day is selected by the system to compete with the video with the highest heart rating in the same category or sub-category, which is also selected by the system.

In one embodiment, the video with the highest star rating may participate only once in a Battle competition against the video with the highest heart rating.

In Battle mode, a user may be allowed to award coins to videos competing against each other. In one embodiment, coins may only be awarded to videos in the Battle section by user in Battle mode. In one embodiment, a user may rate a video he or she likes by awarding it gold, silver, or bronze coins, up to five coins altogether. In one embodiment, a user may not give coins to both videos which are competing against each other. Rather, the user may only award coins to one of the videos. If a user awards coins to a video that subsequently wins the competition, the user may win coin awards, as described herein.

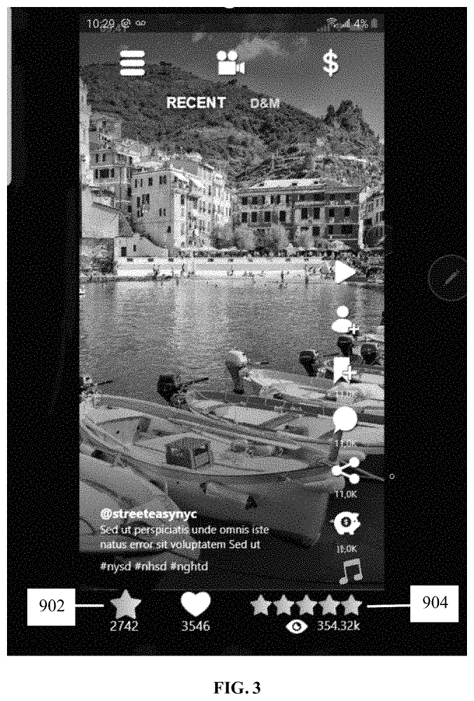

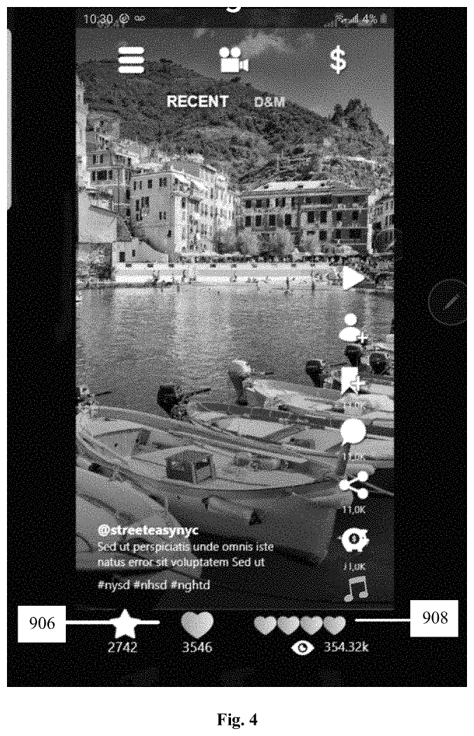

Referring again to FIG. 5, the left image (1004) represented a video awarded the greatest number of stars from the previous day. The right image (1004) represents the video with the greatest number of hearts. The number of given stars or hearts may be displayed below the respective images/videos, along with the creators' and videos' names, as shown in FIGS. 3-4. The coin icons 1008 indicate the number and type of coins the user gave to a competitor. The bottom of the image shows two selectable control button icons for users to select the type and/or denomination of coin to award a video.

In one embodiment, the system enables an award system where users can win awards based on their interaction with, and rating of, creator content. For example, users can win both star/hearts and coin awards. According to one embodiment, stars or hearts may be awarded to users who award stars or hearts to the top three videos that win the most stars and hearts from all users in a 24-hour period. The top three videos may be named the gold, silver, and bronze winners.

For purposes of determining the amount of the star or heart award to users, the value of each star or heart awarded to the gold winner may be four times higher than the value of each star awarded to the bronze winner, and the value of each star awarded to the silver winner may be two times higher than the value of each star awarded to the bronze winner. A star award multiplier, x, may be calculated to determine the number of stars to award to users. The star or hearts award multiplier may be calculated by using the total stars or hearts awarded by all users to videos displayed in a 24 hours period and the total stars or hearts awarded by all users to the top three videos, according to the formula: (total stars/hearts awarded to gold winner)*(4×)+(total stars/hearts awarded to silver winner)*(2×)+(total stars/hearts awarded to bronze winner)*(1×)=total stars/hearts awarded by viewers in 24 hours.

For example, say users awarded 828 stars to 52 video clips that were displayed in a category during a 24-hour period. The three videos out of the 52 that were awarded the most stars become gold, silver, and bronze winners, based on their finish in the top three. Suppose 41 stars, 30 stars, and 48 stars, were awarded to the gold, silver, and bronze winner, respectively. Thus, according to the example provided, the equation is 41(4×)+30(2×)+48×=823. Thus, the star award multiplier x is 3.025. Thus, the value of one star awarded to the gold, silver, and bronze winner is 12.1, 6.05, and 3.025, respectively, according to that star's value.

The star award multiplier may be multiplied by the number of stars a viewer awarded to the top three videos, according to that star's value, and the result is rounded up to the next whole number, to determine the viewer's star award. In this example, if viewer A awarded 5 stars to the gold winner, he will win 61 stars (5*4*3.025). If viewer B is awarded 3 stars to the silver winner, he will win 19 stars. If viewer C awarded 4 stars to the bronze winner an, he will win 13 stars.

In order to provide fair voting, the system may calculate the value of stars taking into the number of new users as system usage increases. That is, any clip which was recently uploaded to the system will potentially get more views than the previously uploaded clip and have a bigger chance to win. The algorithm of fair voting helps to avoid this situation. In this regard, the system may maintain the queue based on normalized star/heart number. For example, the queue may be ordered based on total system users logged in within the recently uploaded period divided by the number of stars/hearts earned by the clip and the queue may be ordered based on users per star or heart.

According to one embodiment, coins are also awarded to viewers who award coins to the winning video in a Battle between two videos. In a competition, the video that wins the greater number of points is the winner of the competition. Points may be calculated by the number of coins received and their value. For purposes of determining points, the value of each gold coin awarded is four times higher than the value of each bronze coin awarded and two times higher than the value of each silver coin awarded.

Thus, for example, in a competition between clip A and clip B, if clip A receives 32 gold coins, 84 silver coins, and 61 bronze coins, it has 357 points, calculated by 32*4+84*2+61*1=357. If clip B receives 58 gold coins, 32 silver coins, 50 bronze coins, it has 346 points. Thus, clip A is declared the winner.

A coin award multiplier may be used to determine the coin award to viewers. The coin award multiplier may be calculated based on the sum of all coins of a type awarded in a competition divided by the sum of coins of that type awarded to the winner. Thus, in this example, the gold coin multiplier is (32+58)/32=2.8. Similarly, the silver coin multiplier and bronze coin multiplier may be 1.4 and 1.8, respectively.

The users are awarded coins based on the calculation of the number of coins of a type awarded to the winner of Battle multiplied by the coin multiplier, and the result may be rounded up to the next whole number. For example, if Viewer D awarded 3 gold coins, 1 silver coin, and 1 bronze coin to Clip A, the winner, he will win 9 gold coins, 2 silver coins, and 2 bronze coins. In one embodiment, stars and coins won by users using the system may be redeemed for cash rewards or prizes from the system online store.

At the end of each month, the system will preferably determine the videos that have been awarded the highest rating of likes. The rating of likes occurs as a result of the balance between video's number of likes and dislikes divided by the number of days in Trends. For example, for the 5 days being in Trends video A gets 10,576 likes and 2,015 dislikes. (10,576−2,015)/5=1,712 is the Rating number for the video A. Every 24 hours the system calculates a new rating number for each video. The higher the rating, the higher position in the Trends queue. Referring again to FIG. 2, an interface of a computing device showing recently uploaded video according to an embodiment of the present invention is provided. As can be seen, the interface includes a menu icon 802 selectable for navigating the application functionality, including between the various interface screens discussed herein. An exemplary menu interface screen is shown in FIG. 19. A mode tab 804 may be provided that indicates the selected mode and may be selectable to navigate between modes. The category and/or category of the given media may be displayed as a hashtag 810. The $ symbol button 806 allows the user at any time to change his/her stars, hearts and coins status from the active (purchased) mode to inactive (free) mode. By tapping the $ button (806) one time, user enables active status of his/her stars, hearts or coins and may start using them for voting. By tapping it twice, user disables active status and may start using his/her inactive stars, hearts and coins for voting. The interface screen may further include one or more interaction buttons, including autoplay 812, follow 814, favorites 816, share 818, gratuity 822, and music library 824 buttons/icons. Finally, a description of the video may also be provided 828.

Referring to FIG. 3-4, an interface of a computing device showing recently uploaded video according to embodiment of the present invention is provided. In these screens, the screens further include a star and heart control button 902 and the user's given stars for that particular video 906, or a heart control button 906 and the user's given hearts for that particular video 908. If the user has not given any stars or hearts, the user may do so by selecting the number of stars to assign to the recent video being displayed.

Referring to FIG. 5, an interface of a computing device showing a Battle between participants with respect to the recently uploaded video according to one embodiment of the present invention is provided. The Battle interface screen includes indicia showing the Battle mode having been enabled 1010. This screen may further include coin control buttons 1006 and the user's given coins 1008 to the elected participant video. The user may add coins to the battle between participants by selecting the desired coin icon, e.g., silver, bronze, gold, etc. The participants of the given battle are shown 1004 as well as the place in the battle queue 1002.

Referring to FIG. 6, an interface of a computing device showing Trends with respect to the uploaded video according to one embodiment of the present invention is provided. This interface screen preferably provides identification of the mode selected 1110, as well as icons 1102 for the user to indicate whether the user likes or dislikes the video and the balance of the number of likes and dislikes for the given video 1104.

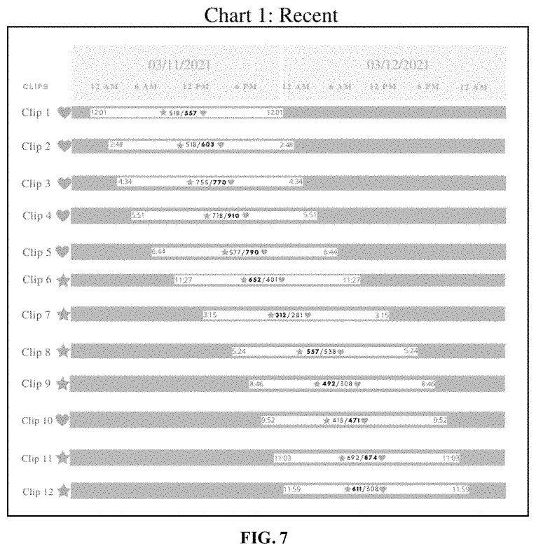

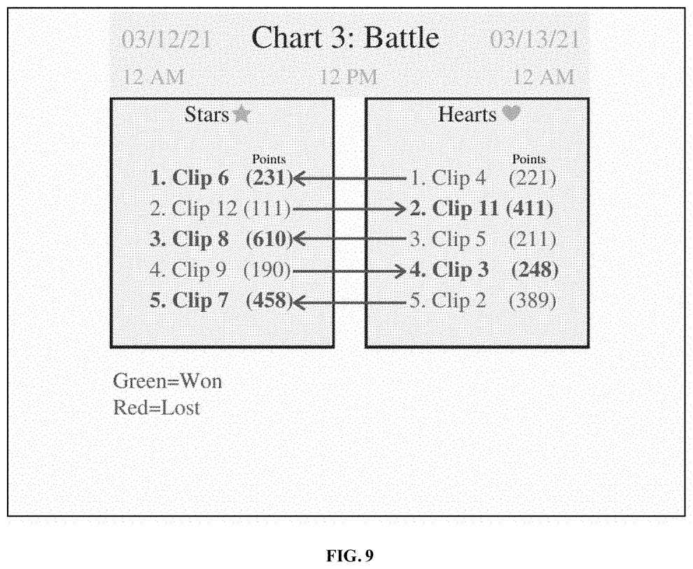

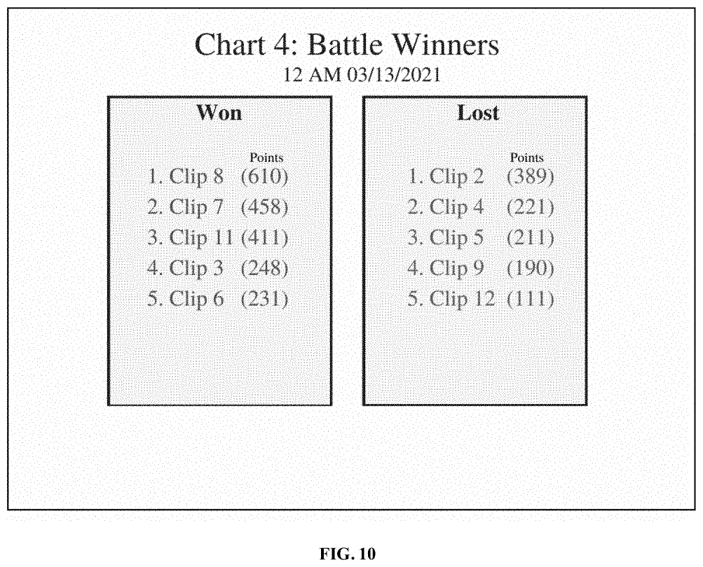

FIGS. 7-12 depict charts for use in understanding the functionality of the systems disclosed herein, as will be discussed in greater detail below. The system generally provides a web platform for content creators to share their media creations with other users of the platform. As discussed above, the system solves one or more of the problems apparent in prior social media systems that skew content discovery toward more popular users and/or users with deeper pockets. In this regard, the system provides a platform for content discovery that is not tied to a content creator's popularity and/or wealth. In one embodiment, this is achieved by providing every user with the same opportunity to have his or her content rated based on the quality of the performance. This unbiased quality rating can thereafter be used to provide content to users.

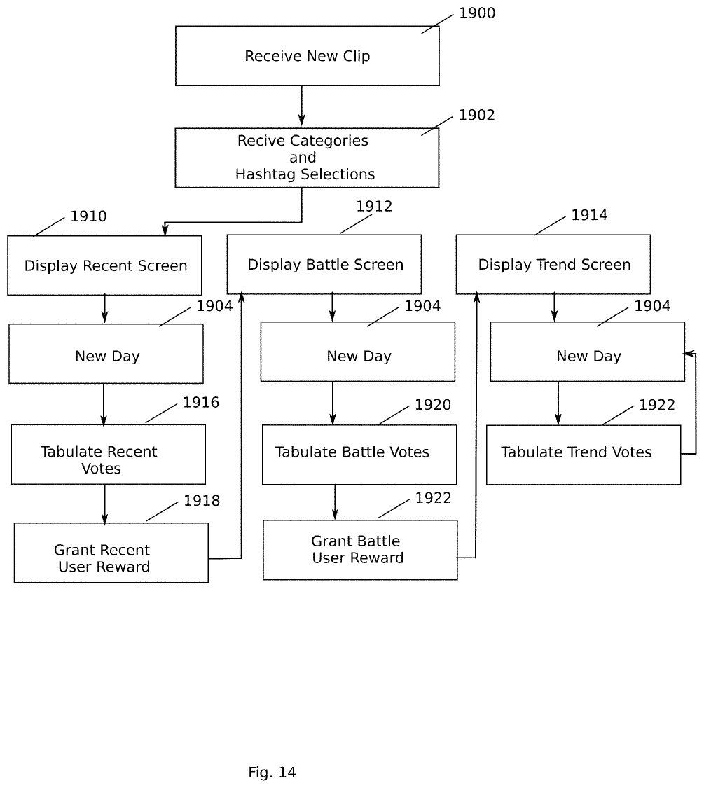

Referring to FIG. 14, a process for viewing, rating, and ranking creative content shared online according to at least one embodiment of the present invention is provided. In one embodiment, the process begins with a user opening the application and the system displaying a first interface screen in response. Preferably, the system opens the app in a Recent mode 1910. In the Recent mode, the user is directed to the Recent section where he/she can watch (as a viewer) recently uploaded videos without having to register for the service, i.e., participate as a guest. The user will preferably be provided the same interaction icons with respect to the video as registered users, but will not be allowed to give starts, hearts, coins, or interact in any other way disclosed herein without first registering with the platform.

As discussed above, the system enables content creators to upload media to the system. In this regard, the content creator may upload a new video clip that is received by the system 1900. The content creator will further be enabled to specify categories and/or sub-categories, in which instance the system will correspondingly receive the specified categories and/or sub-categories and associate this information with the video clip in one or more databases 1902. For each new clip received, the system will cause the new clip to be displayed in the Recent section/interface screen 1910 for the recency period measured based on upload date and time.

In one embodiment, the system grants users a bonus of one or more interaction points, such as starts, hearts, and/or coins periodically, such as daily. In this regard, the system determines if a new calendar day has passed 1904 and grants to users based thereon bonus interactions points. For example, each user may get a daily free bonus of 25 STARS, 25 HEARTS and 30 COINS (10 gold, 10 silver, 10 bronze). Preferably, the daily bonus of STARS, HEARTS and/or COINS or other interaction points not spent by the user within 24 hours will be revoked and thus reset at the end of the time period (daily).

As discussed herein, the platform will preferably provide operation in several modes or sections, preferably Recent, Battle, and Trends modes. These modes generally represent three rounds of the competitive battle. In this regard, the system displays a section screen associated with each of the sections or modes. For example, a Recent, Battle, and/or Trends mode screens may be displayed 1910, 1912, 1914, respectively, upon or in response to navigation requests by users to enter any given mode. Each one of these modes will include videos at any given time that are exclusive to the mode, based on the recency, battle, and trends periods of times, as discussed herein.

In the Recent section, users are preferably able to rate video clips or other media with the interaction points granted by the platform, such as with stars and/or hearts. The system preferably tabulates the number of interaction points, the next calendar after the recency period has passed (e.g., 24 hours) 1904 for all videos received in a given calendar day and identifies based thereon the top, e.g., three, video clips as the winners of the first round 1916, as shown in FIG. 7. In the instance where two different types of points are tracked, the system identifies winner of each of the different types of points, e.g., a star winner and a heart winner. Preferably, the system grants to users that voted for the winning clips Recent type user rewards 1918, such as in the form of stars and/or hearts.

In the Battle section, users are able to rate winning video clips using a second point system, e.g., coins in various denominations, e.g., gold, silver, and/or bronze. The system preferably tabulates the number of battle points, after the battle period passes 1904, and identifies based thereon the winner of the “second” round 1920. Preferably, the system grants to users that voted for the winning clip Battle type user rewards 1922, such as in the form of coins.

In the Trends section, users are able to rate clips using likes and/or dislikes. In this mode, all clips are competing against each other. The highest net rated video clip will become the winner of a third round 1922 and the trends functionality is repeated daily 1904 as videos transfer into the Trends mode section as shown and discussed herein.

As discussed herein, content is divided into a plurality of categories, such as Dance & Music (D&M), Laugh Out Loud (LOL), Vibes, Speak out, News & Views, and Other. Moreover, each category may further be broken down into a plurality of subcategories, as follows. Battle mode may be conduced for each of the categories and/or subcategories, such as those shown in Table A.

TABLE A

| d&m: | | lol: | | vibes: | | speak out: | | news & views: | |
|---|---|---|---|---|---|---|---|---|---|
| 1. | #dance | 1. | #joke of the day | 1. | #me | 1. | #iconfess | 1. | #world |
| 2. | #pop/rock | 2. | #pranks | 2. | #glam | 2. | #like/hate | 2. | #myworld |
| 3. | #hip-hop/rap | 3. | #stand up | 3. | #positive | 3. | #once upon a time | 3. | #challenges |
| 4. | #jazz/classical | 4. | #parody | 4. | #xtraordinary | 4. | #not afraid | 4. | #debates |
| 5. | #retro | 5. | #funny yids | 5. | #buds&butts | 5. | #quotes | 5. | #lifehacks |
| 6. | #dm.other | 6. | #loLother | 6. | #vbs.other | 6. | #so.other | 6. | #nv.other |

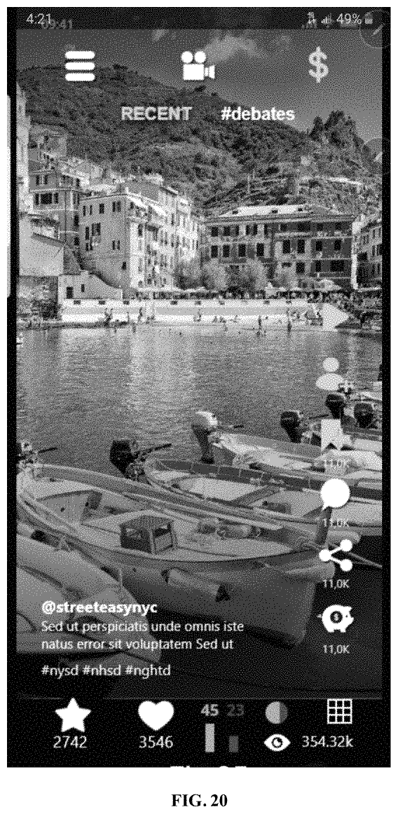

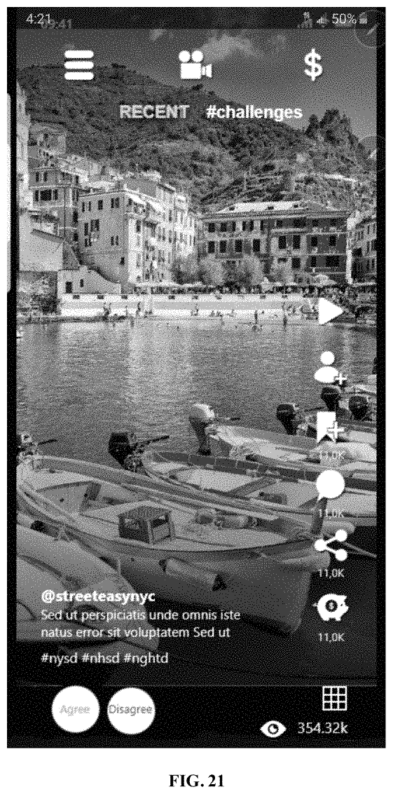

With respect to the #debates hashtag, this subcategory allows users and creators to participate in a joint discussion on various topics. By entering #debates, each user will be asked to choose between two options: Agree or Disagree. The system will calculate the number of users in each group and will show a poll chart on the user's screen. In order to participate in a specific topic, the user will need to enter the screen with all of the debates. The #challenges subcategory allows creators and users to jointly participate and choose their favorite challenges and winners. In order to choose the topic, the user will need to enter the screen with all of the challenges. Creators (content up-loaders) may choose a category and one hashtag/subcategory suitable for the video clip or may create his or her own hashtag. Exemplary interface screens for the debate are shown in FIGS. 20-21, As can be seen in FIG. 21, icons indicating the results of the debate may be shown in the Recent mode along with the results of other interactions.

The system preferably enforces rules for the management of the platform. For example, video clips may be limited in time, for example, to 6 minutes. Therefore, the system may determine rule compliance each time the user is uploading a new clip and if satisfied set or reset interaction points for the uploaded video clip.

In a preferred embodiment, the system maintains uploaded video clips in the Recent and/or Battle section for a limited time, such as 24 hours. In this regard, the system maintains a timer for each of the videos that starts at upload. If the video clip has not expired with respect to this timer, the video clip will be viable for display in the Recent section/mode as a recently uploaded clip, and may be viewed and voted on by other users. If the video clip has expired, the clip will be removed from the Recent modes and tabulations/rewards may be granted to users.

As discussed herein, users may use the platform as guests. However, only registered users may benefit from certain functions, such as winning exclusive gifts as a result of the Battle modes, etc. In one embodiment, guests may be granted and he allowed to vote/rank with points that mirror but are not fungible with the registered user point system. For example, registered users may be awarded and are able to purchase active stars, hearts, or coins by tapping Buy button (as shown in FIG. 16) whereas guest users may be awarded inactive (free) stars, hearts, or coins. The trends votes may be free and indistinguishable between users. Interaction points must be given to the winning clips before the points can be converted into cash or gifts. Interaction points not given to the winning clip cannot be converted into cash or gifts.

After creator uploads his video to the Recent section, the system starts the video dip countdown timer. During this time, the video should accumulate a maximum number of stars and hearts from users. After participating in the Recent section, each clip is moved on the next available calendar day to the Battle section for a second time period, e.g., 24 hours. Unlike the Recent section tinier (which is individual for each clip), the Battle section has a joint timer for all clips. That is, Battles will be tabulated each calendar day. From the Battle section, the clips will be moved to the Trends section for an additional time period, e.g., 24 hours. This way, each clip will get an equal opportunity to be viewed by a large audience. Preferably, timer information is system only and not revealed to others.

The system will preferably maintain a queue of video clips in one or more of the modes. For example, the system may maintain a Battle queue sorted based on the amount of stars or hearts received in the Recent section, as shown in FIG. 7. The position in the Trends section may depend on the amount of battle points earned by a video while in the Battle mode.

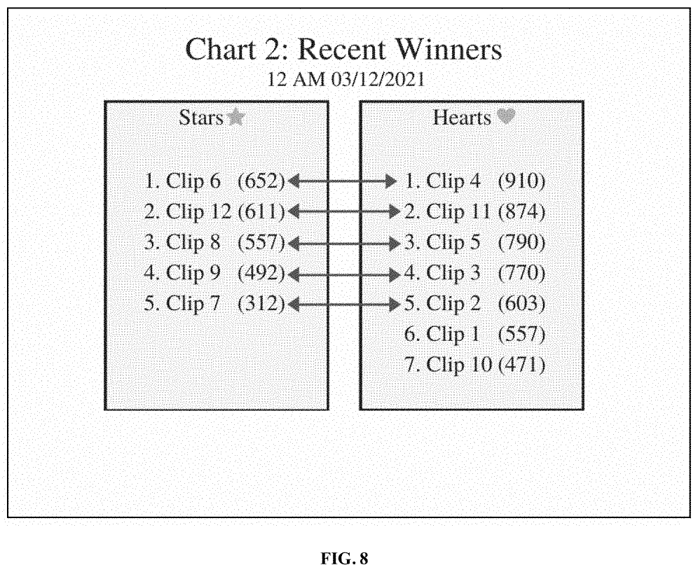

Each user can rate clips he/she likes by giving them stars (up to 5 stars) or hearts (up to 5 hearts). The stars represent the performance skills of the clip and hearts the appearance skills of the clip. The clip which collects the largest amount of stars will take the highest place in the stars queue and the hearts similarly in the hearts queue. The stars and hearts may only be used in the Recent section. Therefore, users may award the first level of interactions points during the Recent mode. The top 3 videos with the highest number of stars and top 3 videos with the highest number of hearts will become the winners of the Recent section. Users who gave their stars or hearts to the top 3 stars and the top 3 hearts videos will become the winners of the Recent Section. The clips with the same position in the stars and hearts queues will compete against each other in the Battle section. For example, clip A that gets 51 stars and takes the 17th place in the star queue will battle against clip B that gets 217 hearts and takes the 17th place in the hearts queue. Beyond a certain threshold, clips exceeding a position in the queue may be moved directly into the trends section, as shown in FIG. 8-10.

Coins are preferably used only in the Battle section. That is, users can give videos they like up to five coins of different denominations. If the user spends all of the active coins, the user may purchase more from the platform store. Users may spend inactive coins as well, which are granted freely. However, only active coins may be traded for cash or gifts as discussed herein. Preferably, users can only give coins to one side of the battle.

As discussed above, winners in the Battle section move on to the Trends section. The clip's position in the Trends section will depend initially on the number of points in the Battle section. Thereafter, clip ranking may be based on the number of views and likes/dislikes.

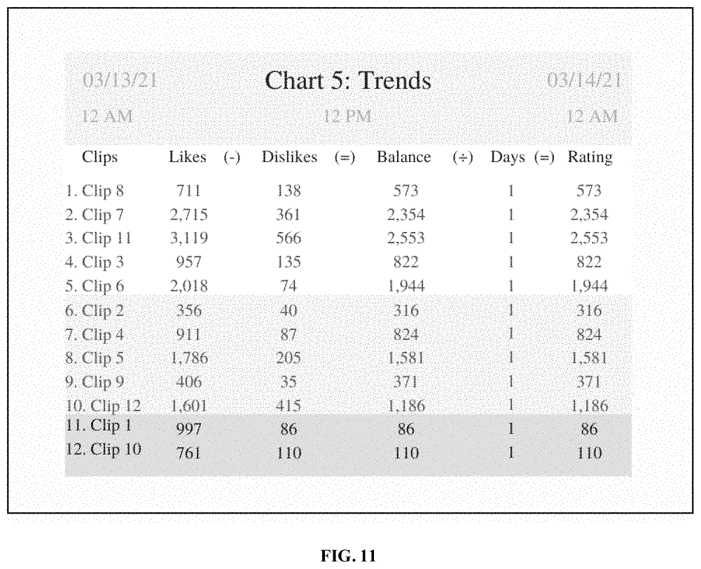

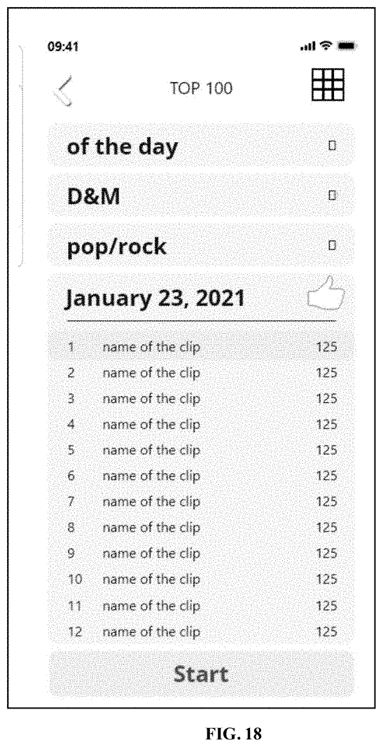

After the Trends section timer expires, position will depend on the average daily rating number of likes, as shown in FIG. 11. If the number of dislikes exceeds the likes over a given period of time (e.g., 7 days), the clip may be removed from the Trends section platform. If the clip regains sufficient likes, the clip may be restored back to the Trends section. Clips with the highest like ratings may be awarded weekly, monthly, yearly, etc. rewards. In one embodiment, a list of all-time top rated video clips may be provided in an interface screen, such as the screen shown in FIG. 18

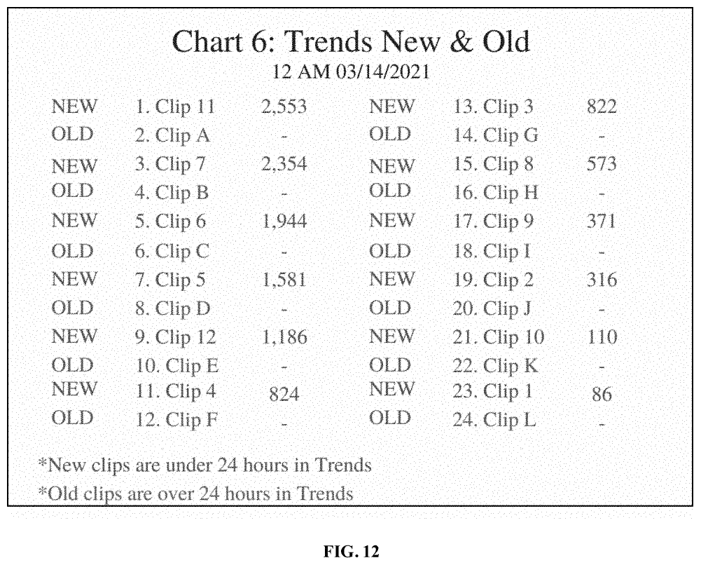

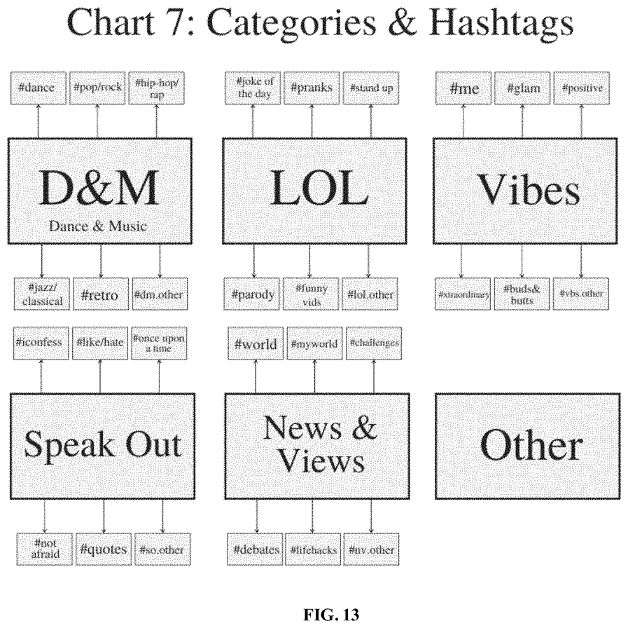

In one embodiment, clips are designated as either new or old. That is, new clips are those coming in from the Battle mode within the Trends timer. Clips that exceed the Trends timer are designated old. The Trends queue may be maintained to alternative between new and old trending clips, as shown in FIG. 12. Alternatively or additionally, winning, losing, and non-competing clips may be presented separately, as shown in FIG. 11.

The interface screens are preferably navigable using a device with a touchscreen. In this regard, the software enables navigation using gestures, including tapping and swiping. For example, users can switch between modes by tapping the mode selection tabs or other navigation elements. Users will preferably be able to activate certain categories and/or subcategories. In this regard, swiping may be configured to allow users to swipe left or right to navigate between the activated categories, subcategories, and/or sections/modes. In one embodiment, swiping up or down allows users to navigate between videos within a category or subcategory. In one embodiment, if the user has not activated a category (off), the system will display mixed clips in one Section from all available categories. However, if a category or subcategory is activated. The system will display clips from the selected category or subcategory. If Section Recent Battle, Trends) is on and Category is off, the system will preferably display nixed clips in one Section from all categories. Once the Category (D&M or others) is on, the system will preferably display the clips in one Section (Recent, Battle, Trends) only from the chosen Category (D&M or others).

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A system for ranking creative content online, the system comprising at least once computing device communicatively coupled to a plurality of other devices over a computer network, the at least one computing device configured at least to:
cause a first interface screen to be displayed on at least one of the plurality of the other computing devices, the first interface screen including therein at least one form element for a content creator to upload media content to the at least one computing device;
receive and mark the uploaded media content with an upload date and time;
assign the media content received to one of a plurality of modes, comprising a recent mode, wherein the media content is assigned to the recent mode and continues to be associated with the recent mode for a first period of time that begins at the upload date and time;
cause a second interface screen to be displayed on the plurality of the other devices, the second interface screen including a plurality of selectable tabs each corresponding to the plurality of the modes, including a recent tab that when selected displays media content associated with the recent mode, the second interface screen comprising at least one selectable icon for users to assign a first rating to media content associated with the recent mode.

2. The system of claim 1, wherein first period of time is a set amount of time for all media content.

3. The system of claim 1, the second interface screen comprising at least one other selectable icon for users to assign a second rating to media content associated with the recent mode, the first and second ratings representing different media characteristics.

4. The system of claim 1, the at least once computing device further configured to assign the media content received to a second of a plurality of modes, comprising a battle mode, wherein the media content is assigned to the battle mode at a next available calendar day after a completion of the first time period and continues to be associated with the battle mode for a second period of time.

5. The system of claim 4, the at least once computing device further configured to assign the media content received to a third of a plurality of modes, comprising a trend mode, wherein the media content is assigned to the trend mode after a completion of the second time period and continues to be associated with the battle mode for a third period of time.

6. The system of claim 5, wherein the second interface screen includes a battle tab that when selected displays media content associated with the battle mode, the second interface screen comprising at least one selectable icon for users to assign a third rating to media content associated with the battle mode.

7. The system of claim 6, wherein the third rating comprises a currency and wherein the at least one icon comprises a plurality of coins at different denominations, and wherein the at least one computing device tabulates a total of the currency earned at a completion of the third period of time.

8. The system of claim 7, wherein the at least one computing device periodically credits system users with points for use in each of the ratings.

9. The system of claim 6, wherein the second interface screen includes a trend tab that when selected displays media content associated with the trend mode, the second interface screen comprising at least one selectable icon for users to assign a fourth rating to media content associated with the trend mode.

10. The system of claim 9, wherein the fourth rating comprises likes and wherein the at least one icon comprises a like icon and a dislike icon, and wherein the at least one computing device tabulates net likes at a completion of the third period of time.

11. The system of claim 10, wherein at least one computing device removes media content from the trend mode when net likes fall below a threshold.

12. The system of claim 7, wherein the media content can only be assigned to one of the plurality of modes, and wherein the at least one computing device transfers the media content between modes automatically upon completion of the respective period of times.

13. The system of claim 7, the second interface screen comprising at least one other selectable icon for users to assign a second rating to media content associated with the recent mode, and wherein the at least one computing device tabulates the first and second ratings at the complete of the first period, and assigns media content having a highest of the first and second ratings to the battle mode.

14. The system of claim 13, wherein, in the battle mode, media content having the highest first rating is paired against media content having the highest second rating.

15. The system of claim 13, wherein the at least one selectable icon allows users to assign a limited amount of currency to media content associated with the battle mode.

16. The system of claim 13, wherein the at least one computing device identifies at least one battle mode winner for each of a plurality of categories of media content.

17. The system of claim 16, wherein the at least one computing device awards points to users rating winning media content.

18. The system of claim 16, wherein the at least one computing device tabulates normalized ratings and identifies at least one battle mode winner based on normalized totals.
